(19) United States
(12) Patent Application Publication
(10) Pub. No.: US 2007/0204809 A1
(43) Pub. Date: Sep. 6, 2007

(54) Pet chill collar

(76) Inventor: Linda Markfield, Los Angeles, CA (US)

Correspondence Address: Lawrence S. Cohen;Suite 1220, 10960 Wilshire Blvd., Los Angeles, CA, 90024, US

(21) Appl. No.: 11/595,575

(22) Filed: Nov. 9, 2006

Related U.S. Application Data
(60) Provisional application No. 60/734,896, filed on Nov. 9, 2005.

(51) Int. Cl. A01K 27/00

(52) U.S. Cl. 119/856

(57) ABSTRACT

A collar for a pet such as a dog is made of a material such as plastic and has an interior chamber with a fluid or gel inside that can be cooled so that it can be applied to the pet to provide cooling. It can be made in a sealed version or it can be made with an opening for adding and/or removing the fluid. The color can be closed, or it can have terminal ends that come together and can be fastened, so as to facilitate applying it to the pet. One of the terminal ends can be provided with an opening and stopper for filling and emptying.

### RELATED APPLICATIONS

This application is a regular utility patent application based on and claiming priority from provisional application number 60/734,896 filed on Nov. 9, 2005, the entire content of which is incorporated herein by reference.

### FIELD OF THE INVENTION

The present invention relates generally to pets and more particularly to a chill collar or cooling collar to help keep pets cool.

### BACKGROUND OF THE INVENTION

Some pets can get over-heated when in high temperatures. This is particularly true for larger pets and pets with thick, long coats. Many pet owners end up owning what are essentially cold weather animals in warm climes. This can lead to heat related problems for some such breeds. Examples of such are Saint Bernards, Huskies, Akitas, etc (although this list is not intended to be exhaustive).

In the art it has been known that excessive heat can sometimes create discomfort and problems for such animals. To address this problem, two “chill collars” are known in the industry. One such chill collar utilizes a scarf that is soaked in water and then refrigerated or frozen and then placed about the neck of the animal. Unfortunately, this can be messy.

Another known device involves a collar with absorbent crystals. The crystals are provided to absorb water and then as the water evaporates, the evaporation cools the animal.

There is, therefore, a need in the industry for an improved apparatus that helps keep pets cool and that solves the above-described shortcomings and other related unrelated shortcomings.

### SUMMARY OF THE INVENTION

Briefly described, in a first preferred form the present invention includes a collar for cooling an animal having a somewhat rigid, yet moldable hollow body and an interior chamber within the body for containing water. The water in the collar is frozen prior to use on an animal. Preferably, the body is formed of resilient tubing, such as round rubber or plastic tubing. In one exemplary embodiment, the body of the collar can have an opening for adding fluid to the interior chamber and/or removing fluid from the interior chamber. In another exemplary embodiment, the body has at least one open end for adding fluid to or removing fluid from the interior chamber. The collar can be substantially ring-like in shape, or the collar can be partially ring-like in shape. Preferably, the body of the collar is uninsulated.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and the detailed description of the invention are exemplary and explanatory of preferred embodiments of the invention, and are not restrictive of the invention, as claimed.

### BRIEF DESCRIPTION OF THE DRAWINGS

FIGS. 1 and 2 show a chill collar around the neck of a dog according to an exemplary embodiment of the present invention.

FIG. 3 is a cross-sectional view of the collar of FIGS. 1 and 2.

FIG. 4 is a view of a chill collar according to another exemplary embodiment of the present invention.

### DETAILED DESCRIPTION

The present invention may be understood more readily by reference to the following detailed description of the invention taken in connection with the accompanying drawings figures, which form a part of this disclosure. It is to be understood that this invention is not limited to the specific devices, methods, conditions or parameters described and/or show herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular values. Similarly, when values are expressed as approximations, by use of the antecedent “about,” it will be understood that the particular value forms another embodiment.

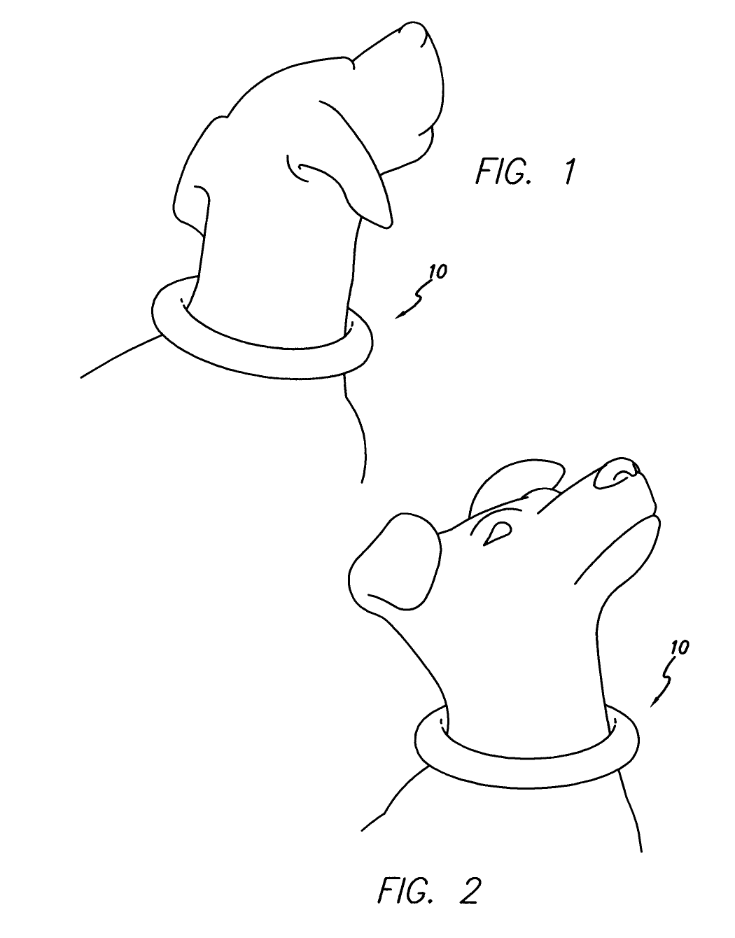

FIGS. 1 and 2 show a chill collar 10 around the neck of a dog. Those skilled in the art will understand that the chill collar 10 of the present invention can be used with various other peters, including both cats and dogs.

Preferably, the collar 10 has a hollow body 12. The body 12 houses an interior chamber 14 therein for containing a fluid such as water or a liquid gel. Preferably, the body 12 is constructed of a durable and moldable material, such as round plastic or rubber tubing. Those skilled in the art will understand that various other materials can be employed as well for the body 12.

Prior to use, the collar 10 can be placed in a freezer until the fluid in the interior chamber 14 freezes. The collar 10 is then placed over the head of the animal and around its neck so as to keep the animal cool and comfortable for a few hours on warm days while the animal is playing, walking, sleeping, waiting in a car, etc. Thus, the collar 10 can help keep animals from overheating. The collar can be used repeatedly. Once the fluid in the interior chamber 14 melts and no longer provides any cooling effect, the collar can be refrozen and then reused.

Preferably, the collar has a “closed ring” construction such that the interior chamber 14 is sealed in the collar 10. Thus, in such construction, fluid cannot be added or removed. IN such an embodiment, the collar 10 is generally ring-shaped such that it fits over the head of an animal and around the animal's neck. Also, in such embodiment, the collar 10 itself in not size-adjustable so as to accommodate animals of widely different sizes (or in other words, the collar 10 would be a single, fixed collar). Thus, separately sized and shaped collars can be manufactured to accommodate animals of widely different sizes.

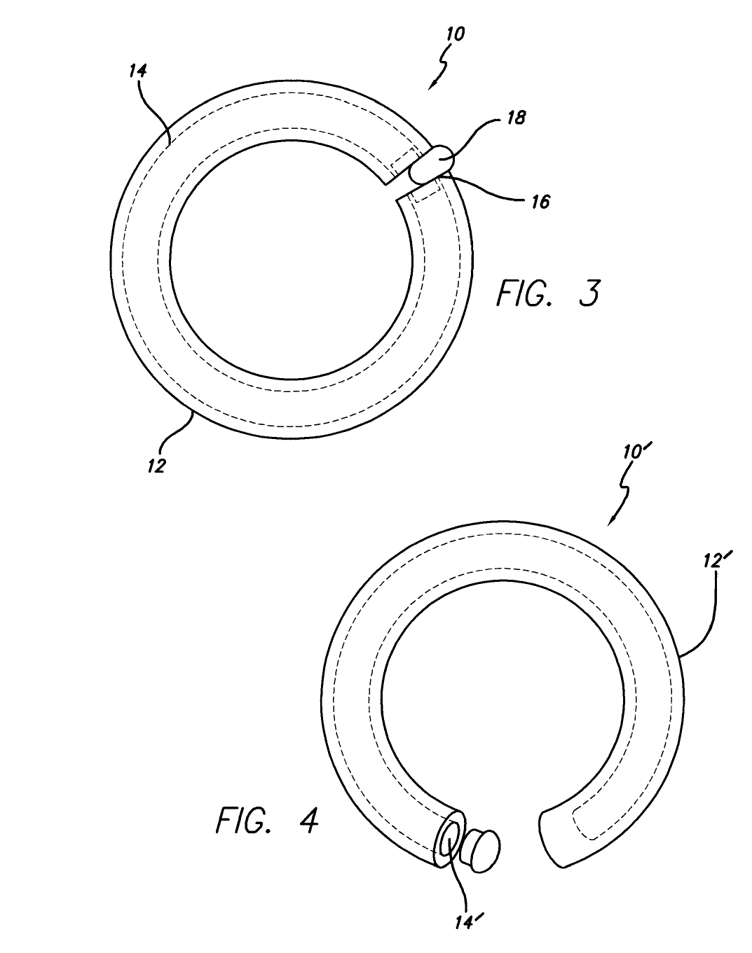

Optionally, the body 12 of the “closed ring” collar can include an opening 16, as shown in FIG. 3, through which fluid can be added to the interior chamber 14 or removed from the interior chamber. The opening 16 can also include a plug 18 that can be manually removed to insert fluid and inserted to prevent the fluid from escaping the interior chamber 14.

In another exemplary embodiment (shown in FIG. 4), the collar 10′ can have an “open ring” construction such that it is constructed of a piece of tubing that is open at one of both ends. The collar 10′ of the “open ring” construction can be manipulated by a person so as to add or remove fluid from the interior chamber 14′ or to change the shape of the collar. For example, both ends can be open such that fluid is added to the tubing, and then the collar can be closed into a generally ring-like structure by fitting one end snugly within the other end. Or, both ends can be capped with removable caps, and the structure can be molded in a partially ring-like or generally U-shaped structure prior to freezing. Or, one end can be closed, while the other end has a removable cap 18′, as shown in FIG. 4. In such embodiments, the collar can be bent into a generally or partially ring-like structure prior to freezing. When the collar is partially ring-like, the collar can optionally include fasteners, such as ties, straps, or the like, to keep the collar around the neck of the animal. Also, once the water melts, the animal can drink the water. Moreover, such “open ring” constructions provide for a universal collar such that the collar can be cut or otherwise reduced to fit animals of smaller sizes.

As shown herein, the collar 10 is uncovered in the sense that it does have an insulator around the body 12. Thus, the collar 10 serves to coo the animal directly. However, the collar 10 can include a washable covering so that the slick plastic tubing of the collar does not directly contact the animal's fur/skin.

Those skilled in the art will understand that the collar 10 can be made of various shapes, sizes, and colors so as to accommodate the animal that will wear the collar without deviating from the scope of the present invention. In exemplary embodiments, the size of the tubing used for the body 12 is between ¾ inch and 1 ½ inches in diameter, and the length of the body 12 appropriate to create a collar with a diameter of about 5 to 10 inches. In exemplary embodiments, the body 12 and/or the fluid in the interior chamber 14 can be colored with one or more colors or dyes.

While the invention has been described with reference to preferred and example embodiments, it will be understood by those skilled in the art that a variety of modifications, additions and deletions are within the scope of the invention, as defined by the following claims.

What is claimed is:

1. A collar for cooling an animal, comprising:
a somewhat rigid, yet moldable hollow body; and
an interior chamber within the body for containing water, wherein said collar is frozen prior to use on an animal.

2. The collar of claim 1, wherein the body is formed of resilient tubing.

3. The collar of claim 2, wherein the body has an opening for adding fluid to the interior chamber and/or removing fluid from the interior chamber.

4. The collar of claim 2, wherein the body has at least one open end for adding fluid to or removing fluid from the interior chamber.

5. The collar of claim 1, wherein the collar is substantially ring-like in shape.

6. The collar of claim 1 wherein the collar is partially ring-like in shape.

7. The collar of claim 1, wherein the body is uninsulated.

8. The collar of claim 1, wherein the body is made of a flexible material flexible enough to allow it to be pulled into an open position and resilient enough that it will close to a closed position when released and having an open-ring form defining ends that meet.

9. The collar of claim 8, wherein a fastener is proximate the ends in the closed position and may be fastened to secure the collar in place.

10. The collar of claim 9, wherein at least one of the ends has an opening for allowing a cooling medium to be added to and/or removed from the interior chamber and a closure for the opening.

11. A method for providing cooling for an animal comprising;
providing a collar that has a body that has an interior chamber;
the interior chamber having a cooling medium therein;
cooling the cooling medium;
applying the collar to the neck of the animal.

12. The method of claim 11 further comprising;
providing an opening in the body for adding and/or removing cooling medium into and/pr from, respectively, the interior chamber.

13. The method of claim 12 further comprising;
providing at least one open end of the body for adding and/or removing cooling medium.

14. The method of claim 11 further comprising;
forming the body from a plastic material in a substantially ring-like shape.

15. The method of claim 11 further comprising;
forming the body from a plastic material in a partial ring-like shape.

16. The method of claim 11 further comprising;
forming the body from material that will allow cooling to be available from the medium in the interior chamber exteriorly.

17. The method of claim 11 further comprising;
forming the body from flexible resilient material in an open-ring construction defining ends that meet.

18. The method of claim 17 further comprising;
providing a fastener proximate the ends to allow the collar body to be applied and removed when the fastener is in an open position and to keep it in place when the fastener is in a closed position.
